(19) United States
(12) Patent Application Publication
(10) Pub. No.: US 2010/0064051 A1
(43) Pub. Date: Mar. 11, 2010

(54) COMMUNICATION TERMINAL

(75) Inventor: Masahiko TAMIYA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/409,754

(22) Filed: Mar. 24, 2009

(30) Foreign Application Priority Data
Sep. 5, 2008 (JP) P2008-228754

(51) Int. Cl. G06F 15/16

(52) U.S. Cl. 709/230

(57) ABSTRACT

To appropriately save a power consumed during a refresh operation. In a communication terminal according to the present invention, a storage unit stores a timetable of refresh operations related to one or plural statuses in a cellular phone. A control unit determines whether or not a current time is a refresh operation start time at which any one of refresh operations starts, the refresh operation start time being described in the timetable stored by the storage unit. A control unit generates a refresh signal related to one or plural predetermined statues described in the timetable in accordance with the refresh operation start time, if a control unit determines that a current time is the refresh operation start time. A control unit transmits the generated refresh signal to the server in a first state where a connection with the server is established, via an antenna and a transmitting circuit.

### BACKGROUND OF THE INVENTION

1. Field of the Invention

The present invention relates to a communication terminal and more particularly to a communication terminal such as a cellular phone capable of mutually exchanging presence information with any other communication terminal.

2. Description of the Related Art

The IMS is a communication method standardized by the CDMA network 3GPP or 3GPP2 as a standards body for 3G cellular phones. The IMS is a communication method that integrates public communication services provided on a fixed-line network and a mobile communication network, into IP (Internet Protocol) and SIP (Session Initiation Protocol) in order to realize a multimedia service.

In recent years, there has been known a service that allows plural networked communication terminals such as cellular phones to mutually exchange current presence information with one another based on an IMS-Presence function (see “3GPP TS 23.228, for example). For example, communication terminals using this service successively register current presence information in a presence server. The presence server manages presence information of each communication terminal and supplies the managed presence information related to one communication terminal to another one as required.

The specifications of the IMS-Presence function define that each communication terminal and a server automatically and periodically communicate with each other to match a status (status of each communication terminal) with a corresponding status in the server. The operation for matching statuses with each other is called “refresh operation”. According to the specifications of the IMS-presence function, the refresh operation is generally performed once every several hours. Further, in some cases, it is necessary to update plural statuses of each communication terminal upon the refresh operations. In such cases, in general, modules for managing each status are designed to refresh the statuses not in sync with each other (independently of each other).

However, the following problem occurs: if plural statuses of any communication terminal are refreshed not in synchronization with each other, power consumption in the communication terminal increases in proportion to the number of refresh operations.

### SUMMARY OF THE INVENTION

The present invention has been accomplished in view of the above circumstances, and it is accordingly an object of the present invention to provide a communication terminal capable of suitably saving a power consumed during a refresh operation.

To attain the above object, a communication terminal according to the present invention includes: a connecting unit configured to connect to a server via a network; a storage unit configured to store a timetable of refresh operations related to one or plural statuses in the communication terminal; a determination unit configured to determine whether or not a current time is a refresh operation start time at which any one of refresh operations starts, the refresh operation start time being described in the timetable stored by the storage unit; a generating unit configured to generate a refresh signal related to one or plural predetermined statues described in the timetable in accordance with the refresh operation start time, if the determination unit determines that a current time is the refresh operation start time; and a transmitting unit configured to transmit the refresh signal generated by the generating unit to the server in a first state where a connection with the server is established by the connecting unit.

To attain the above object, a communication terminal according to the present invention includes: a connecting unit configured to connect to a server via a network; a determination unit configured to set a predetermined timer for each status of the communication terminal and determine whether the set predetermined timer expires; a generating unit configured to generate a refresh signal related to the first status or refresh signals for a plurality of statuses including statuses other than the first status in accordance with a state of the timer for each status, if the determination unit determines that a timer for a first status as a reference status among statuses in the communication terminal expires; and a transmitting unit configured to transmit the refresh signal generated by the generating unit to the server in a first state where a connection with the server is established by the connecting unit. According to the present invention, a power consumed during a refresh operation can be saved as appropriate.

### BRIEF DESCRIPTION OF THE DRAWINGS

FIG. 1 shows the schematic configuration of a network system according to the present invention;

FIGS. 2A and 2B show an external configuration of the cellular phone applicable to a communication terminal according to the present invention;

FIGS. 3A and 3B show another external configuration of the cellular phone applicable to a communication terminal according to the present invention;

FIG. 4 shows an internal configuration of a cellular phone applicable to a communication terminal according to the present invention;

FIG. 5 shows a protocol structure of the SIP;

FIG. 6 shows refresh operation intervals of statuses A to D and the numbers of refresh operations for statuses A to D in a day;

FIG. 7A shows the number of refresh operations for statuses of a conventional cellular phone, and FIG. 7B shows the number of refresh operations for statuses of a cellular phone according to the present invention;

FIG. 8 shows a waveform of a power consumed during one refresh operation in a conventional cellular phone;

FIG. 9 is a flowchart showing refresh signal transmitting processing in a cellular phone of FIG. 4;

FIG. 10 shows a structural example of a timetable of refresh operations for statuses prestored in a storage unit;

FIG. 11 shows a waveform of a power consumed during a refresh operation according to the present invention;

FIG. 12 shows another structural example of the timetable of refresh operations for statuses prestored in a storage unit; and

FIG. 13 is another flowchart showing the refresh signal transmitting processing in a cellular phone of FIG. 4

### DESCRIPTION OF THE PREFERRED EMBODIMENTS

Hereinafter, an embodiment of the present invention will be described with reference to the accompanying drawings.

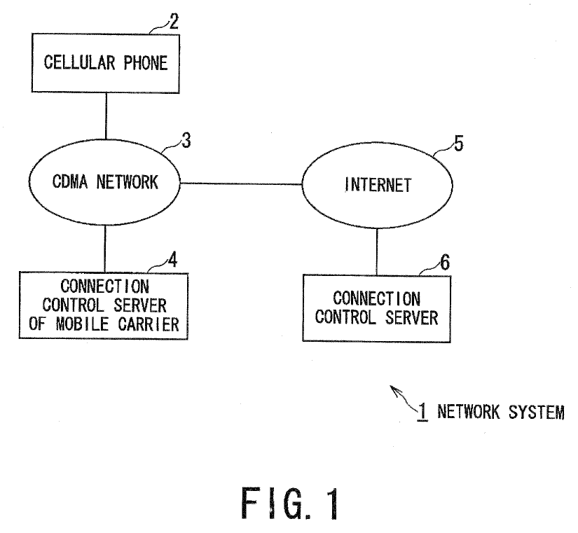

FIG. 1 shows the schematic configuration of a network system 1 according to the present invention. As shown in FIG. 1, in the network system 1, a base station as a fixed radio station is provided in each cell of a desired size in a coverage area of a communication service. The base station is connected with a cellular phone 2 (applicable to a communication terminal of the present invention) as a mobile wireless station by radio based on a W-CDMA. The cellular phone 2 can communicate data at high speed. To be more specific, the cellular phone 2 can transmit/receive a large amount of data using a 5 [MHz] bandwidth in a 2 [GHz] frequency band at 2[Mbps] if standing still and at 384 [Kpbs] if moving.

The base station is connected to a CDMA network 3 as a mobile carrier network through a wired line. The CDMA network 3 is connected to a connection control server of mobile carrier 4 managed by a mobile carrier. The connection control server of mobile carrier 4 controls connections within the CDMA network 3 as the mobile carrier network. Further, the CDMA network 3 is connected to an Internet 5 as a public Internet network. The Internet 5 is connected to a connection control server 6 including an SIP server and a presence server on the Internet.

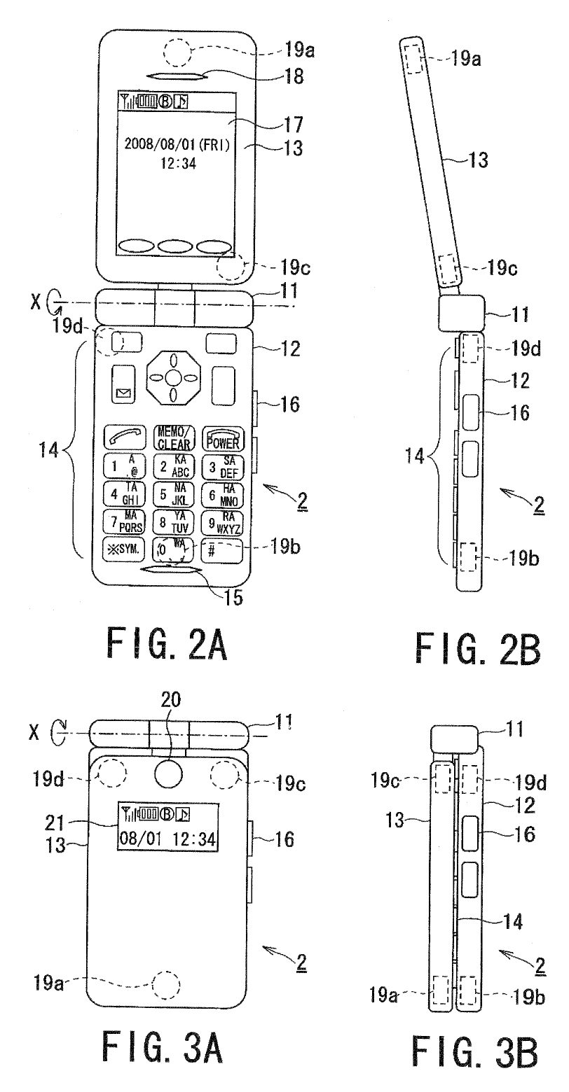

FIGS. 2A and 2B show an external configuration of the cellular phone 2 applicable to a communication terminal of the present invention. FIG. 2A is a front view of the external configuration of the cellular phone 2 that is opened at about 180 degrees. FIG. 2B is a side view of the external configuration of the opened cellular phone 2.

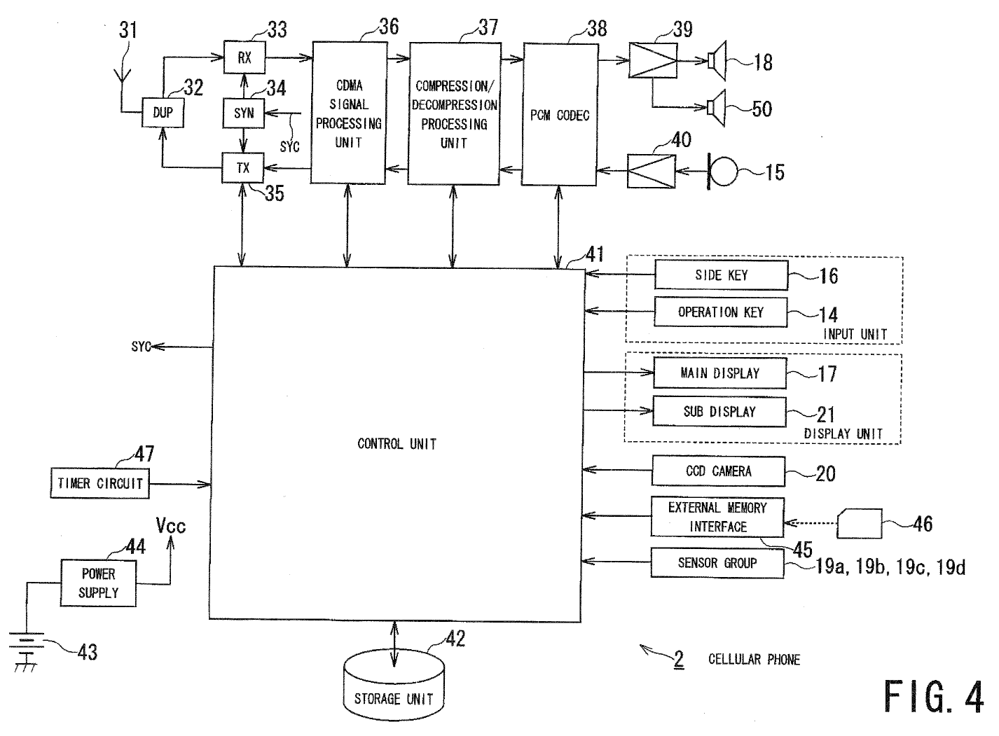

As shown in FIGS. 2A and 2B, the cellular phone 2 includes a first casing 12 and a second casing 13 that are hinge-connected to each other with a hinge part 11 in the middle. The cellular phone 2 is formed so as to be foldable in an arrow X direction via the hinge part 11. A transmitting/receiving antenna (antenna 31 in FIG. 4 as described later) is provided at a predetermined position inside the cellular phone 2. The cellular phone 2 may transmit/receive radio waves with the base station through the built-in antenna.

On the surface of the first casing 12, arranged are operation keys 14 such as alphanumeric keys “0” to “9”, a outgoing call key, a redial key, a power key, a clear key, and a mail key. Various instructions can be input using the operation keys 14.

In an upper portion of the first casing 12, arrow keys and an enter key are provided as the operation keys 14. A user can move a placed cursor to upward, downward, leftward, and rightward directions by pressing up, down, left, and right arrow keys. More specifically, these keys are used to perform various operations such as scrolling through an address book or an e-mail screen displayed on a main display 17 in the second casing 13 or switching the page or image on a simplified website.

Further, various functions can be selected and confirmed by pressing the enter key. For example, if a user operates arrow keys to select a desired one from plural phone numbers in the address book displayed on the main display 17 and presses the enter key toward an inner portion of the first casing 12, the first casing 12 confirms the selected phone number and calls the number.

In addition, a mail key is provided on the left of the arrow keys and the enter key. If the mail key is pressed toward the inner portion of the first casing 12, a mail transmitting/receiving function can be invoked. A browser key is provided on the right of the arrow keys and the enter key. If the browser key is pressed toward the inner portion of the first casing 12, data on the Web page can be browsed.

Moreover, a microphone 15 is provided below the operation keys 14 in the first casing 12. The microphone 15 collects user's voice during a voice call. In addition, the first casing 12 is provided with a side key 16 for operating the cellular phone 2.

A battery pack is inserted to be attached on the back of the first casing 12. When the power key is turned on, the battery pack supplies power to each circuit unit to set the units operable.

On the other hand, the second casing 13 has the main display 17 provided on the front thereof. The main display 17 displays a reception state of the radio wave, a remaining battery level, destination names and phone numbers registered in the address book, a transmission history, content of e-mail messages, simplified homepages, images picked up by a charge-coupled device (CCD) camera (a CCD camera 20 of FIGS. 3A and 3B described below), content received from an external content server, and content stored in a memory card (a memory card 46 of FIG. 4 described below). Further, a telephone receiver (earpiece) 18 is provided at a predetermined position above the main display 17 to allow a user to make voice call. In addition to the telephone receiver 18, a speaker (speaker 50 in FIG. 4) is also provided as a voice output unit at a predetermined position on the cellular phone 2.

Magnetic sensors 19a, 19b, 19c, and 19d are provided at predetermined inner positions of the first casing 12 and the second casing 13 and used to detect a state of the cellular phone 2. Here, the main display 17 may be configured using either an organic EL display or a liquid crystal display.

FIGS. 3A and 3B show another external configuration of the cellular phone 2 applicable to a communication terminal according to the present invention. In the illustrated examples of FIGS. 2A and 2B, the opened cellular phone 1 in FIGS. 1A and 1B is turned in the direction of the arrow X. FIG. 3A is a front view showing the external configuration of the closed cellular phone 1, and FIG. 3B is a side view showing the external configuration of the closed cellular phone 1. The CCD camera 20 is provided in an upper portion of the second casing 13. A desired object image can be captured using this camera. A sub display 21 is provided below the CCD camera 20 to display an antenna pictograph indicating a current sensitivity level of an antenna, a battery, pictograph indicating a current battery power of the cellular phone 3, and a current time.

FIG. 4 shows an internal configuration of the cellular phone 2 applicable to a communication terminal according to the present invention. A radio signal transmitted from the base station is received by the antenna 31, passes through an antenna duplexer (DUP) 32, and is input to a receiver (RX) 33. The receiver 33 may perform mixing of the received radio signal with a local oscillation signal output from a frequency synthesizer (SYN) 34 to down-convert the received radio signal into an intermediate frequency signal. Then, the receiver 33 generates a reception baseband signal by performing a quadrature demodulation (quadrature detection) on the down-converted intermediate frequency signal. The receiver 33 outputs the generated baseband signal to a CDMA signal processor 36. The frequency of the local oscillation signal generated from the frequency synthesizer 34 is indicated by a control signal SYC output from a controller 41.

The CDMA signal processor 36 is provided with a RAKE receiver. In the RAKE receiver, a plurality of paths included in the reception baseband signal are de-spread with respective spread codes (i.e., spread codes equivalent to those of the spread reception signals). Then, after the phase in the despread signals of the respective paths is adjusted, the despread signals of the respective paths are coherently RAKE-combined by the RAKE receiver. A data series obtained through the Rake combining is subjected to de-interleaving, channel decoding (error correction decoding), and binary data determination. Thus, reception packet data in a predetermined transmission format can be obtained. The reception packet data is input to a compression/decompression processor 37.

The compression/decompression processor 37 is composed of a digital signal processor (DSP). The compression/decompression processor 37 separates the reception packet data output from the CDMA signal processor 36 in a multiplexer/demultiplexer for each media, and perform a decoding processing on the separated data for each media. For example, in a call mode, speech data included in the reception packet data and corresponding to spoken voice is decoded by a speech codec. If video data is included in the reception packet data, such as in the case of a videophone mode, the video data is decoded by a video codec. For example, if the reception packet data is downloaded content, the downloaded content is decompressed (expanded) and output to the controller 41.

A digital speech signal obtained by decoding is supplied to a PCM codec 38. The PCM codec 38 PCM-decodes the digital speech signal output from the compression/decompression processor 37, and outputs an analog speech signal obtained by the PCM decoding to a receiving amplifier 39. The analog speech signal is amplified by the receiving amplifier 39 and output by the telephone receiver 18.

A digital video signal obtained through decoding performed by the compression/decompression processor 37 at the video codec is input to the controller 41. The controller 41 causes the main display 17 to display, via a video RAM such as a VRAM, a video image based on the digital video signal output from the compression/decompression processor 37. The controller 41 causes the main display 17 to display, via the RAM, not only a received video data but also a video data picked up by the CCD camera 20.

If the reception packet data is an e-mail message, the compression/decompression processor 37 supplies the e-mail message to the controller 41. The controller 41 causes a storage unit 42 to store the e-mail message supplied from the compression/decompression processor 37. Then, in response to the user's operation of the operation keys 14 included in an input unit, the controller 41 reads the e-mail message stored in the storage unit 42 and causes the main display 17 to display the read e-mail message.

On the other hand, in the call mode, a speaker's (user's) speech signal (analog speech signal) input to the microphone 15 is amplified to a proper level by a transmitting amplifier 40 and PCM-coded by the PCM codec 38. A digital speech signal obtained by the PCM coding is input to the compression/decompression processor 37. A video signal output from the CCD camera 20 is digitized by the controller 41 and input to the compression/decompression processor 37. An e-mail message, which is text data generated by the controller 41, is also input to the compression/decompression processor 37.

The compression/decompression processor 37 may compression-code the digital speech signal from the PCM codec 38 in a format corresponding to a predetermined transmission data rate. Thus, speech data is generated. Also, the compression/decompression processor 37 compression-codes the digital video signal from the controller 41 so as to generate video data. Then, the compression/decompression processor 37 causes the multiplexer/demultiplexer to multiplex the speech data and the video data into transmission packet data in accordance with a predetermined transmission format. The compression/decompression processor 37 packetizes the data multiplexed in the multiplexer/demultiplexer. The compression/decompression processor 37 outputs the transmission packet data after the packetization to the CDMA signal processor 36. When an e-mail message is output from the controller 41, the compression/decompression processor 37 similarly causes the multiplexer/demultiplexer to multiplex the e-mail message into transmission packet data.

The CDMA signal processor 36 uses a spread code assigned to a transmission channel to perform spread spectrum processing on the transmission packet data output from the compression/decompression processor 37, and outputs an output signal generated by the spread spectrum processing to a transmitter (TX) 35. The transmitter 35 modulates the signal after the spread spectrum processing by using a digital modulation method such as a QPSK (Quadrature Phase Shift Keying) method. The transmitter 35 synthesizes the transmission signal after the digital modulation with the local oscillator signal generated from the frequency synthesizer 34 to up-convert the transmission signal into the radio signal. Then, the transmitter 35 high-frequency-amplifies the radio signal generated by the up-conversion so as to obtain the transmission power level indicated by the controller 41. The high-frequency-amplified radio signal is supplied via the antenna duplexer 32 to the antenna 31, and is transmitted from the antenna 31 to the base station.

The cellular phone 1 has an external memory interface 45, which has a slot allowing insertion and withdrawal of the memory card 46. The memory card 46 is a type of flash memory card typified by a NAND flash memory card and a NOR flash memory card. Various types of data, such as images, speech, and music can be written to and read from the memory card 46 via a 10-pin terminal. The cellular phone 1 further has a clock circuit (timer) 47 for accurate measurement of the current time.

The controller 41 includes a central processing unit (CPU), a read only memory (ROM), and a random access memory (RAM). The CPU performs various types of processing according to a program stored in the ROM or various application programs loaded from the storage unit 42 to the RAM, generates various control signals, supplies the control signals to various sections, and thus controls the overall operation of the cellular phone 1. The PAM stores data necessary for the CPU to perform various types of processing.

The storage unit 42 is composed of a hard disk drive (HDD) or a flash memory device, which is a nonvolatile memory allowing electrical writing and erasing. The storage unit 42 stores various data groups and various application programs to be executed by the CPU in the controller 41. A power circuit 44 generates a predetermined operating supply voltage Vcc on the basis of an output from a battery 43 and supplies the operating supply voltage Vcc to each circuit unit.

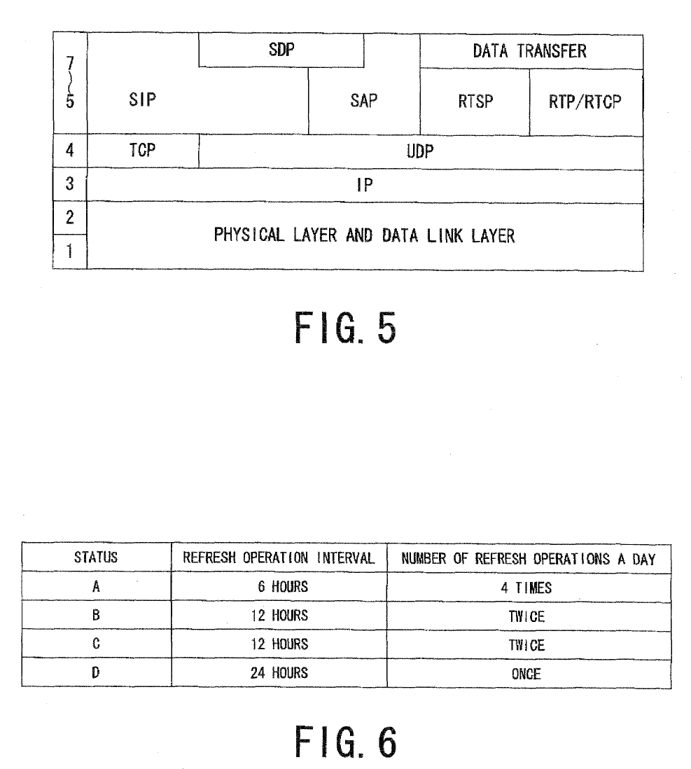

Further, the cellular phone 2 enables an IP phone using various communication protocols. If the IP phone function is performed on the cellular phone 2, the control unit 41 executes a communication protocol defined by the SIP as a call control protocol on an IP network. FIG. 5 shows a protocol structure of the SIP. As shown in FIG. 5, in the protocol structure, IP is set on a physical layer and a data link layer as a network layer, and TCP or UDP is set on IP as a transport layer. In addition, upper layers such as SIP, SAP, SDP, and RTSP are set on TCP or UDP.

The control unit 41 has a status management function for realizing an IMS-Presence function, which is a characteristic structure of the present invention. The control unit 41 executes the status management function to manage a status to be updated through refreshing based on TCP/IP or UDP/IP. Then, the control unit 41 performs the status management function to carry out a refreshing operation to match statuses on the cellular phone 2 and the connection control server 6 (status of the cellular phone 2). In other words, the control unit 41 executes the refreshing operation at regular intervals to generate a refresh signal related to a predetermined status (“enable” status) in the group of latest statuses of the cellular phone 2 and transmits the refresh signal to the connection control server 6. The refresh signal includes information related to a status of the cellular phone 2, which is managed using the status management function (information representing which status is set in the cellular phone 2). Needless to say, the refresh signal may be generated for a “disable” status.

Conceivable examples of statuses of the cellular phone 2 managed using the status management function of the control unit 41 include an IP communication enabled/disabled status (enable/disable status) of the cellular phone 2, an IP phone reception enabled/disabled status (enable/disable status), a presence transmission enabled/disabled status (enable/disable status), and presence reception enabled/disabled status (enable/disable status). The embodiment of the present intention will be described on the following assumption for ease of explanation. That is, four statuses A, B, C, and D are managed. The status A is “IP communication enabled/disabled status (enable/disable status)”. The status B is “IP phone reception enabled/disabled status (enable/disable status)”. The status C is “presence transmission enabled/disabled status (enable/disable status)”. The status D is “presence reception enabled/disabled status (enable/disable status)”. As shown in FIG. 6, the refresh operation is performed for the statuses A, B, C, and D every 6 hours, 12 hours, 12 hours, and 24 hours, that is, four times, twice, twice, and once per day, respectively.

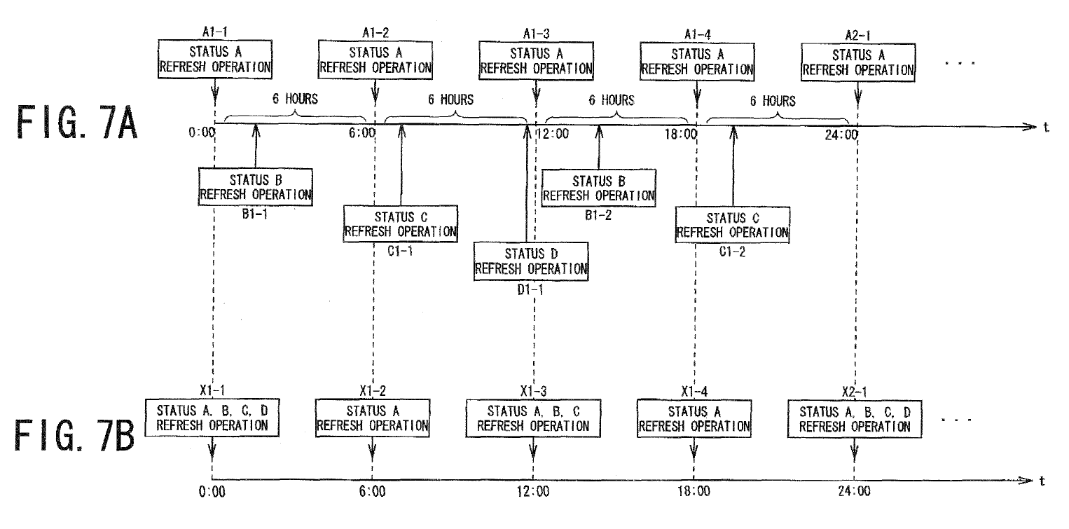

In such cases, according to conventional techniques, modules of the status management function for managing the statuses A to D are designed to carry out refresh operations for the statuses A to D asynchronously (independently of one another). As a result, if the refresh operations for the statuses A to D are executed asynchronously, the total number of refresh operations increases. FIG. 7A shows the number of refresh operations for statuses of the cellular phone 2. As shown in FIG. 7A, the refresh operation for the status A (in FIG. 7A, A1-1 to A1-4) is executed every 6 hours. During intervals between the refresh operations, the refresh operation for the status B (in FIG. 7A, B1-1 and B1-2) is executed every 12 hours, and the refresh operation for the status C (in FIG. 7A, C1-1 and C1-2) is executed every 12 hours. In addition, the refresh operation for the status D (in FIG. 7A, D1-1) is executed every 24 hours. As a result, nine refresh operations based on A1-1 to A1-4, B1-1 and B1-2, C1-1 and C1-2, and D1-1, are executed in total a day.

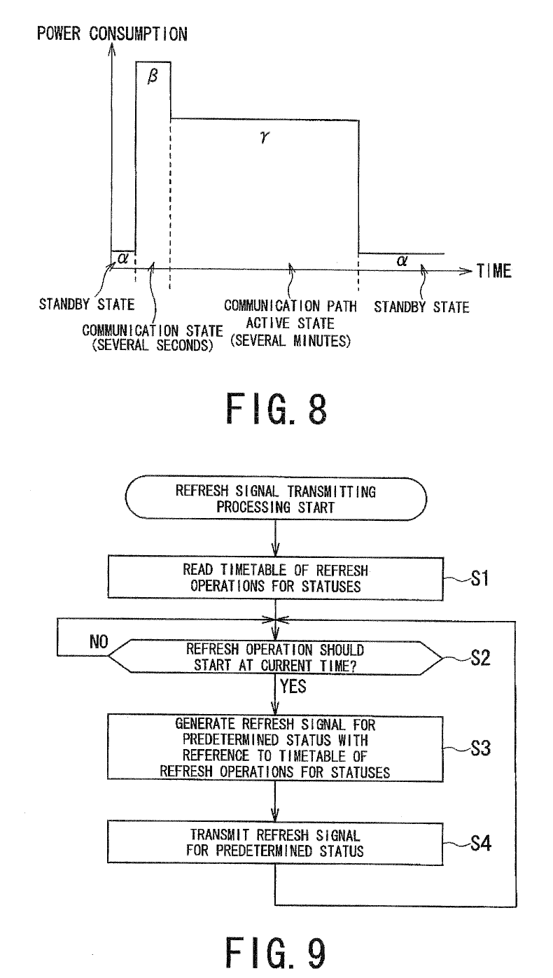

However, if the plural refresh operations for the statuses A to D of the cellular phone 2 are asynchronously performed and the total number of refresh operations increases, power consumption of the cellular phone 2 increases in proportion to the number of refresh operations. FIG. 8 shows a waveform of a power consumed during one refresh operation in the conventional ones. As shown in FIG. 8, if the cellular phone 2 is shifted from a standby state α where no communication is performed to a temporal communication state β, the cellular phone 2 performs communication for several seconds and then stays in a communication path Active state γ for a while (for about several minutes). Then, after the elapse of about several minutes, the cellular phone 2 is shifted from the communication path Active state γ to the standby state α.

In order that an IP phone line stay available for subsequent communications for a while, the cellular phone 2 stays in the communication path Active state γ for a while (for about several minutes) after the cellular phone 2 performs communication for several seconds. However, in the communication path Active state γ, the physical layer is operating, with the result that power consumption is larger than that in the standby state α. Here, power consumption in the communication path Active state γ is uniformly determined.

For example, as shown in FIG. 7A, if nine refresh operations are executed in a day, the total power consumption is nine times as much as a power consumed during one refresh operation in FIG. 8 (more specifically, 9× power consumption in the communication state β+9× power consumption in the communication path Active state γ).

In the embodiment of the present invention, as shown in FIG. 7B, at a reference time set as a time of refresh operation for the status A with the highest frequency of refresh operation among plural statuses or at any preset time adjusted to a timing for the refresh operation for the status A, refresh operations for the other statuses (statuses B to D) are executed. In other words, as shown in FIG. 7B, in a refresh operation X1-1 at 0:00, a refresh operation for all of the statuses A, B, C, and D is performed. In a refresh operation X1-2 at 6:00, a refresh operation for the status A is performed. In a refresh operation X1-3 at 12:00, a refresh operation for all of the statuses A, B, and C is performed. In a refresh operation X1-4 at 18:00, a refresh operation for the status A is performed. As a result, the total number of refresh operations in a day can be reduced. In the example of FIG. 7B, the nine refresh operations can be reduced to four refresh operations. Accordingly, power consumption of the cellular phone 2 that would increase in proportion to the number of refresh operations, can be saved. Refresh signal transmitting processing based on the above, method will be described hereinbelow.

Referring to a flowchart of FIG. 9, refresh signal transmitting processing of the cellular phone 2 is described. Here, in the embodiment of the present invention, it is assumed that a refresh signal is generated for “enable” status; for example, the status A (IP communication enabled/disabled state), the status B (IP phone reception enabled/disabled state), the state C (presence transmission enabled/disabled state), and the status D (presence reception enabled/disabled state) are all “enable” states, and a refresh operation is performed for all of the statuses A to D. However, a user can change the statuses as appropriate.

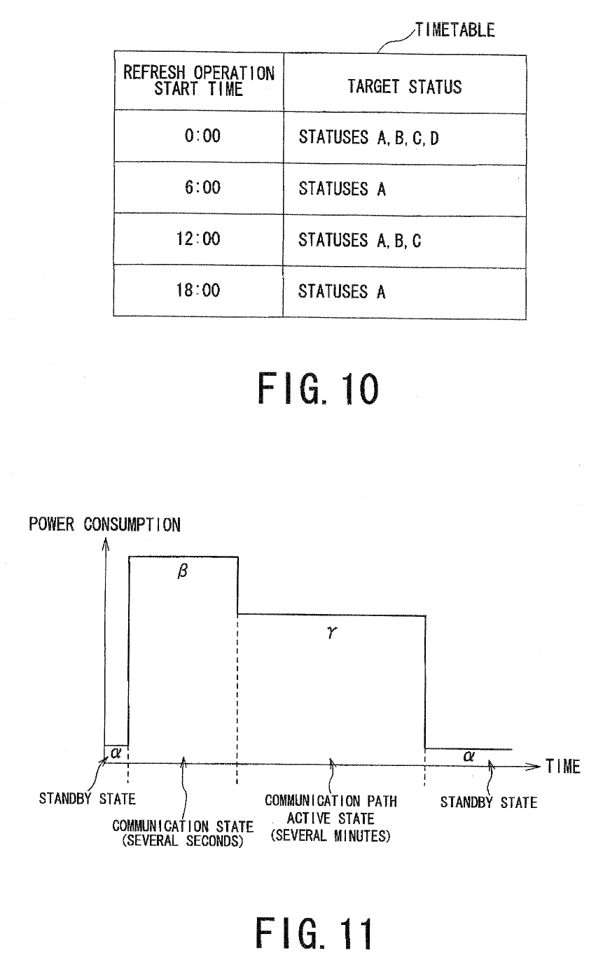

In step S1, the control unit 41 reads a timetable of refresh operations for statuses prestored in the storage unit 42. FIG. 10 shows a structural example of the timetable of refresh operations for statuses prestored in the storage unit 42. As shown in FIG. 10, “0:00” is described as a refresh operation start time. At this refresh operation start time, “statuses A, B, C, and D” are target statuses for refresh operation. Next, “6:00” is described as a refresh operation start time. At this refresh operation start time, “status A” is a target status for refresh operation. Further, “12:00” is described as a refresh operation start time. At this refresh operation start time, “statuses A, B, and C” are target statuses for refresh operation. In addition, “18:00” is described as a refresh operation start time. At this refresh operation start time, “status A” is a target status for refresh operation.

In step S2, the control unit 41 references the read timetable of refresh operations for statuses to determine whether or not a current time is a time at which reference operation starts, with use of the timer circuit 47. The control unit 41 waits until it is determined that a current time is a time at which refresh operation starts. In the case where the control unit 41 determines that a current time is a time at which reference operation starts in step S2, the control unit 41 references the timetable of refresh operations for statuses as to a predetermined status (statuses A to D) to generate a refresh signal related to the predetermined status described in the timetable of refresh operations for statuses. To be specific, if a current time is “0:00”, “statuses A, B, C, and D” are target statuses for refresh operation at this refresh operation start time. Then, the control unit 41 generates refresh signals related to the statuses A to D.

In step S4, the control unit 42 transmits the generated refresh signals related to the predetermined statuses to the connection control server 6 through the antenna 31, the transmitting circuit 35, and the CDMA signal processing unit 36 based on the communication protocol shown in FIG. 5. Next, a description will be given of a waveform of a power consumed in the case where a current time is “0:00” and a refresh operation for the statuses A to D is performed. FIG. 11 shows a waveform of a power consumed during a refresh operation in the case where a current time is “0:00” according to the present invention. In the communication state β, a refresh operation is performed for each of the four statuses A to D. In the communication state β in FIG. 11, since refresh operations for the four statuses A to D are performed in succession, the operations require a time substantially corresponding to the number of statuses compared to a time required to perform a refresh operation for one status. Accordingly, a power substantially corresponding to the number of statuses (power corresponding to four statuses) is consumed.

After that, the cellular phone 2 receives a response to the refresh signals from the connection control server 6 through the CDMA network 3. The regular refresh operations terminate with this operation. After that; the processing returns to step S2, step S2 and subsequent steps are repeated.

With this operation, the timetable of refresh operations for statuses is referenced to perform a refresh operation for a predetermined statuses described in the timetable of refresh operations for statuses. Refresh operations related to predetermined statuses are performed at “0:00”, “6:00”, “12:00”, and “18:00” in this order. Here, if a current time is “6:00”, “status A” is a target status for refresh operation at this refresh operation start time. Also in the case of using the timetable of refresh operations for statuses, an interval between refresh operations for each of the statuses A, B, C, and D (every 6 hours, every 12 hours, every 12 hours, and every 24 hours) is kept.

As a result, as shown in FIG. 7B, the number of refresh operations, which is nine in the conventional cases, can be reduced to four. Along with this, the total power consumption at the nine refresh operations in the communication path Active state γ can be reduced to the total power consumption at four refresh operations in the communication path Active state γ. In other words, in the conventional refresh operation as shown in FIG. 7A, the total amount of a power corresponding to the nine refresh operation in the communication state β and a power corresponding to the nine refresh operation in the communication path Active state γ is consumed, while in the refresh operation according to the present invention, only the total amount of a power corresponding to the nine-refresh operation in the communication state β and a power corresponding to the four refresh operation in the communication path Active state γ is consumed. Thus, power consumption corresponding to five refresh operations (corresponding to the number of omitted refresh operations) in the communication path Active state γ can be saved.

In the embodiment of the present invention, the cellular phone 2 connects to the connection control server 6 through the CDMA network 3 and the Internet 5, and the cellular phone 2 stores a timetable of refresh operation(s) for one or more statuses of the cellular phone 2. The cellular phone 2 determines whether a current time is a refresh operation time at which any one of refresh operations starts, the refresh operation time being described in the timetable stored by the storage unit. The cellular phone 2 generates a refresh signal(s) related to one or plural predetermined statues described in the timetable in accordance with the refresh operation start time, if it is determined that a current time is the refresh operation start time. The cellular phone 2 transmits the generated refresh signal(S) to the connection control server 6 in succession in a first state (communication state β) where connection with the connection control server 6 is established Then, after the refresh signal(s) has been transmitted to the connection control server 6, the first state is shifted to a second state (communication path Active state γ) where connection between the cellular phone 2 and the connection control server 6 is established at least in the physical layer. The second state is kept for a predetermined period.

As a result, the number of refresh operations can be reduced compared with the conventional ones. Along with this reduction, the total amount of power consumed at each refresh operation in the communication path Active state γ can be reduced, and power consumption corresponding to the number of omitted refresh operations in the communication path Active state γ can be saved. Therefore, a power consumed-during refresh operations can be appropriately saved and an operating time of the cellular phone 2 can be elongated.

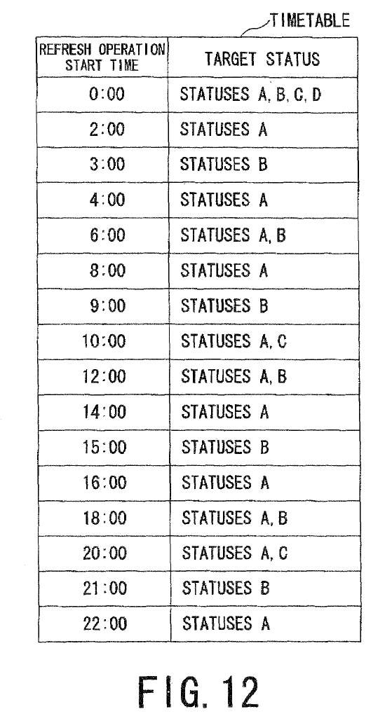

In the embodiment of the present invention, for ease of explanation, it is assumed that the four statuses A, B, C, and D are managed, and refresh operations for the statuses A to D are preformed every 6 hours, 12 hours, 12 hours, and 24 hours, respectively. However, the present invention is not limited thereto. For example, the present invention is applicable to an example where refresh operations for the statuses A to D are preformed every 2 hours, 3 hours, 10 hours, and 24 hours, respectively. In this case, it is assumed that refresh operations for the statuses A to D are preformed 12 times, 8 times, 3 times, and once a day. A timetable as shown in FIG. 12 is used in this case, for example. As shown in FIG. 12, the total number of refresh operations, which is 24 in the conventional ones, can be reduced to 16. Accordingly, power consumption of the cellular phone 2 that would increase in proportion to the number of refresh operations can be saved. Along with this, an amount of power consumed at 24 refresh operations in the communication path Active state γ can be reduced to an amount of power-consumed at 16 refresh operations in the communication path Active state γ. Thus, power consumption corresponding to eight refresh operations in the communication path Active state γ can be saved.

Further, three statuses or less or five statuses or more may be set for the cellular phone 2. Moreover, refresh operations for statuses with predetermined refresh operation intervals may be combined as appropriate. In the embodiment of the present invention, as long as the total number of refresh operations for each status can be reduced only by one, power consumption corresponding to the omitted refresh operation in the communication path Active state γ can be saved.

In the flowchart of FIG. 9, a refresh operation for a predetermined status described in the timetable of refresh operations for statues is performed at a time preset with reference to the timetable (for example, “0:00” or “12:00”. However, the present invention is not limited thereto. For example, a timer may be set for each status, and a statues with the largest number of refresh operations (in other words, with the shortest refresh operation interval) may be used as a reference status to perform refresh operations for the other statues following a refresh operation for the reference status. Hereinbelow, refresh signal transmitting processing using this method will be described.

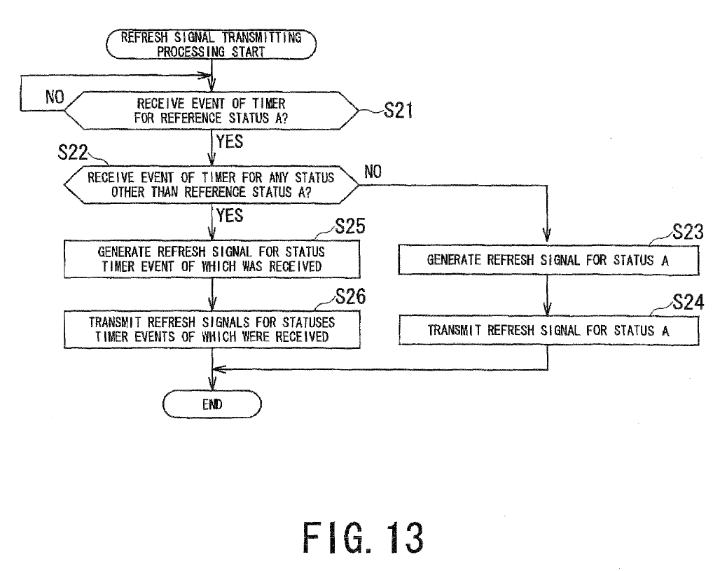

Referring to a flowchart of FIG. 13, the refresh signal transmitting processing in the cellular phone 2 is described next. A timer for each status is set using the timer circuit 47 in each software module for managing each status. The control unit 41 receives an event of the timer for each status at predetermined refresh operation intervals set for each status. The refresh signal transmitting processing illustrated in the flowchart of FIG. 13 is performed on the assumption that the status A with the shortest refresh operation interval of the statues A to D is used as a reference status to perform refresh operations for the other statues following a refresh operation for the reference status.

In step S21, the control unit 41 determines whether an event of a timer for the reference status A has been received and waits until an event of a timer for the reference status A is received. In step S21, if the control unit 41 determines that an event of a timer for the reference status A has been received, the control unit 41 determines whether an event of a timer for any of the statuses B to D other than the status A has been received at around the time when the event of the timer for the status A was received, in step S22.

In step S22, if the control unit 41 determines that an event of a timer for any of the statuses B to D other than the status A has not been received, the control unit 41 generates a refresh signal for the status A in step S23. In step S24, the control unit 41 transmits the generated refresh signal for the status A to the connection control server 6 through the antenna 31, the transmitting circuit 35, and the CDMA signal processing unit 36 based on the communication protocol shown in FIG. 5.

In step S22, if the control unit 41 determines that an event of a timer for any of the statuses B to D other than the status A has been received, the control unit 41 generates refresh signals for the statuses including the status A the timer event of which has been received, in step S25. For example, if events of the timers for the statues B and C as well as the status A have been received, refresh signals for the statuses A to C the timer events of which have been received, are generated.

In step S26, the control unit 41 successively transmits the generated refresh signals for the statuses to the connection control server 6 through the antenna 31, the transmitting circuit 35, and the CDMA signal processing unit 36 based on the communication protocol shown in FIG. 5.

Thus, it becomes possible that the status A with the shortest refresh operation interval of the statues A to D is used as a reference status to perform refresh operations for the other statues B to D following a refresh operation for the reference status, and refresh operations for plural statues can be performed at a time by synchronizing timings to start a refresh operation.

As a result, similar to the above refresh signal transmitting processing in FIG. 9, the number of refresh operations, which is nine in the conventional cases, can be reduced to four. Along with this, the total power consumption at the nine refresh operations in the communication path Active state γ can be reduced to the total power consumption at four refresh operations in the communication path Active state γ. In other words, in the conventional refresh operation as shown in FIG. 7A, the total amount of a power corresponding to the nine refresh operation in the communication state β and a power corresponding to the nine refresh operation in the communication path Active state γ is consumed, while in the refresh operation according to the present invention, only the total amount of a power corresponding to the nine refresh operation in the communication state β and a power corresponding to the four refresh operation in the communication path Active state γ is consumed. Thus, power consumption corresponding to five refresh operations (corresponding to the number of omitted refresh operations) in the communication path Active state γ can be saved.

In the embodiment of the present invention, the cellular phone 2 is connected to the connection control server 6 through the CDMA network 3 or the like, a predetermined timer preset for each status is set for each status of the cellular phone 2 to determine whether the preset timer expires on a status basis. If it is determined that the timer for a first status (for example, the status A) out of the statues of the cellular phone 2 expired, in the case where the timer for the first status expired alone, a refresh signal for the first status is generated. Alternatively, in the case where the timer for any of the statues B to D other than the status A expired, refresh signals for the other statuses as well as the first status are generated. In the first state (communication state β) where connection with the connection control server 6 is established, the generated refresh signals can be sent to the connection control server in succession. As a result, the number of refresh operations can be reduced compared with the conventional ones Along with this reduction, the total amount of power consumed at each refresh operation in the communication path Active state γ can be reduced, and power consumption corresponding to the number of omitted refresh operations in the communication path Active state γ can be saved. Therefore, a power consumed during refresh operations can be appropriately saved and an operating time of the cellular phone 2 can be elongated.

Here, the refresh operations terminate with the cellular phone 2 receiving a response to the connection control server 6. However, under weak field circumstances, it takes some time to terminate the refresh operations. In such cases, even if a predetermined refresh operation interval is preset, a refresh operation start time is shifted little by little by repeating the refresh operation although the predetermined refresh operation interval is kept. The degree of deviation in refresh operation start time might vary among statuses. However, in the illustrated example of FIG. 13, since the status A with the shortest refresh operation interval is used as a reference status to perform refresh operations for the other statues B to D following a refresh operation for the reference status A, even if the refresh operation start time is shifted, refresh operations for plural statuses can be performed at a time by synchronizing timings to start a refresh operation as appropriate.

Further, after the refresh signal has been sent in step S25 or S28, if the cellular phone 2 receives a response from the connection control server 8, a predetermined timer is set for the refreshed status in the timer circuit 47.

The present invention is applicable to a PDA, a personal computer, a portable game machine, a portable music player, a portable DVD player, and other such communication terminals in addition to the cellular phone 2.

The series of processing described in the embodiment of the present invention may be executed using either software or hardware.

Moreover, the embodiment of the present invention describe steps in the flowchart in chronological order (ascending numeric order). However, the present invention encompasses the case where steps are executed in parallel or independently of each other, not in chronological order.

What is claimed is:

1. A communication terminal comprising:
a connecting unit configured to connect to a server via a network;
a storage unit configured to store a timetable of refresh operations related to one or plural statuses in the communication terminal;
a determination unit configured to determine whether or not a current time is a refresh operation start time at which any one of refresh operations starts, the refresh operation start time being described in the timetable stored by the storage unit;
a generating unit configured to generate a refresh signal related to one or plural predetermined statues described in the timetable in accordance with the refresh operation start time, if the determination unit determines that a current time is the refresh operation start time; and
a transmitting unit configured to transmit the refresh signal generated by the generating unit to the server in a first state where a connection with the server is established by the connecting unit.

2. The communication terminal according to claim 1, wherein after the transmitting unit transmits the refresh signal to the server in the first state, the first state is shifted to a second state where the connecting unit connects the communication terminal to the server at least in a physical layer and the second state is kept for a predetermined period.

3. The communication terminal according to claim 2, wherein after the elapse of the predetermined period, the second state is shifted to a third state where the connecting unit substantially completely disconnects the communication terminal from the server except in the physical layer.

4. The communication terminal according to claim 1, wherein refresh operation intervals are determined for each status in the communication terminal, and the timetable is set based on the refresh operation intervals determined for each status.

5. The communication terminal according to claim 1, wherein if the generating unit generates refresh signals for each of a plurality of statuses, the transmitting unit transmits a plurality of refresh signals related to the plurality of statuses to the server in a predetermined order with the first state being kept.

6. The communication terminal according to claim 1, wherein the refresh signal includes information related to a disable status or enable status.

7. A communication terminal comprising:
a connecting unit configured to connect to a server via a network;
a determination unit configured to set a predetermined timer for each status of the communication terminal and determine whether the set predetermined timer expires;
a generating unit configured to generate a refresh signal related to the first status or refresh signals for a plurality of statuses including statuses other than the first status in accordance with a state of the timer for each status, if the determination unit determines that a timer for a first status as a reference status among statuses in the communication terminal expires; and
a transmitting unit configured to transmit the refresh signal generated by the generating unit to the server in a first state where a connection with the server is established by the connecting unit.

8. The communication terminal according to claim 7, wherein after the transmitting unit transmits the refresh signal to the server in the first state, the first state is shifted to a second state where the connecting unit connects the communication terminal to the server at least in a physical layer and the second state is kept for a predetermined period.

9. The communication terminal according to claim 8, wherein after the elapse of the predetermined period, the second state is shifted to a third state where the connecting unit substantially completely disconnects the communication terminal from the server except in the physical layer.

10. The communication terminal according to claim 7, wherein the first status is a status with the shortest refresh operation interval of the statuses in the communication terminal.

11. The communication terminal according to claim 7, wherein if the generating unit generates refresh signals for each of a plurality of statuses, the transmitting unit transmits a plurality of refresh signals for the plurality of statuses to the server in a predetermined order with the first state being kept.

12. The communication terminal according to claim 6, wherein the refresh signal includes information related to a disable status or enable status.
